(19) United States
(12) Patent Application Publication
(10) Pub. No.: US 2022/0227894 A1
(43) Pub. Date: Jul. 21, 2022

(54) CHITOSAN BASED COATING SYSTEM

(71) Applicant: BONA AB, Malmö (SE)

(72) Inventors: John F Schierlmann, Waxhaw, NC (US); Patrick Johnson, Indian Land, SC (US); Pietrina Peshel, Indian Trail, NC (US); Erica Walker, Charlotte, NC (US); Charles Johnson, Monroe, NC (US)

(21) Appl. No.: 17/610,293

(22) PCT Filed: May 18, 2020
(86) PCT No.: PCT/IB2020/000385

§ 371 Date: Nov. 10, 2021

Related U.S. Application Data
(60) Provisional application No. 62/849,655, filed on May 17, 2019.

(51) Int. Cl. C08B 37/08; C09D 7/65; C09D 7/45; C09D 7/42; C09D 133/04; C09D 175/04; C11D 3/22; C09G 1/04; A01N 43/16; A01P 1/00

(52) U.S. Cl. CPC C08B 37/003; C09D 7/65; C09D 7/45; C09D 7/42; A01P 1/00; C09D 175/04; C11D 3/222; C09G 1/04; A01N 43/16; C09D 133/04

(57) ABSTRACT

A chitosan based coating system. The coating system includes a carrier agent and a chitosan based agent preservative. The carrier agent may be a cleaning agent, a polishing agent, and/or a finishing agent. The chitosan based agent may be a chitosan acetate and salts thereof, chitosan citrate acetate and salts thereof, or combinations thereof. The coating system may include 0.01-5 weight percent chitosan based agent. The chitosan based agent functions as a preservative to increase both the shelf-life and use-life of the coating system as well as functions as a chelating agent to reduce soap scum.

### BACKGROUND

The present invention relates to a coating system that incorporates a chitosan based agent. More particularly, the present invention relates to water-based coatings that include a carrier agent, such as a cleaning agent, polishing agent, or finishing agent, and a chitosan based agent, such as chitosan acetate, lactate, citrate acetate and combinations thereof as well as the respective salts thereof, that functions as a preservative and/or chelating agent for the cleaner, polish, or finish coating.

Consumer use products frequently remain on a shelf for several years prior to use. Microbes, such Staphylococcus aureus, Aspergillus brasiliensis, Pseudomonas aeruginosa, Candida albicans, and Escherichia coli, often get into product packaging and attack or feed on components in cleaners, polishes, and finishes. Preservatives are therefore frequently incorporated into water-based products from cosmetics and shampoos to cleaners, paints, and waxes to prevent or limit the attack of such microbes on the water-based material products and thereby prolong the shelf-life and use-life of such products.

To insure that such products maintain their intended performance characteristics, the correct amount of preservative must be utilized. Further, when selecting a particular preservative to incorporate into a product, it is often critical that such preservative does not impact the usability of the underlying product and does not alter the formulated performance characteristics of the underlying product.

Traditional preservatives offer very little or no performance enhancement to the final product. Instead, traditional preservatives have solely limited spoilage. Moreover, traditional preservative formulations in their concentrated form have many hazards associated with them such as corrosiveness, allergens, aquatic hazards, or even mutagenic or carcinogenicity. Thus, preservatives are controlled by and regulated by the United States Environmental Protection Agency, and their approval for trade requires significant scientific testing and screening.

Incorporating preservatives into cleaners and other coatings is a complex issue. Namely, cleaners must maintain little to no residue visible on the surface of laminates, wooden floors, tiles, stone, or ceramic materials. Another issue with cleaners is the need to have near neutral pH 7 so that there is no adverse interaction with the surface over time. Moreover, when formulating gloss or very matte polishes and finishes, adding incompatible material can result in not only a loss of gloss or flocculation, but other unwanted problems like viscosity change, pH drift, or color change.

The present invention relates to water-based coatings that incorporate a naturally derived chitosan based agent for controlling unwanted growth and prolonging the shelf-life and use-life of such products as well as providing the added benefit of a chelating agent.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention; its sole purpose is to present concepts of the invention in a simplified form as a prelude to the more detailed description that is subsequently presented.

The present invention includes a coating system. In one embodiment of the invention, the coating system includes a carrier agent and a preservative that includes a chitosan based agent. The chitosan based agent may be a chitosan acetate and salts thereof, chitosan citrate acetate and salts thereof, or combinations thereof. In one embodiment of the present invention the carrier agent may be a cleaning agent, a polishing agent, and/or a finishing agent.

In an embodiment of the present invention, the coating system may include 0.01-5 weight percent chitosan based agent. In another embodiment of the present invention, the coating system may include 0.01-1.0 weight percent chitosan based agent. In yet another embodiment of the present invention, the coating system may include 0.01-0.10 weight percent chitosan based agent. And in yet another embodiment of the present invention, the coating system may include 0.01-0.8 weight percent chitosan based agent.

Alternatively, the coating system may include 0.01-0.4 weight percent chitosan based agent. In this embodiment, the carrier agent may be a cleaning agent and the chitosan based agent preferably has a pH of less than 7. Further alternatively, the coating system may include 0.01-0.5 weight percent chitosan based agent. In this embodiment, the carrier agent may be a polishing agent or a finishing agent and the chitosan based agent preferably has a pH of 6 to 10.

In an embodiment of the present invention, the coating system includes a pH of 2-7. Further, the chitosan based agent may function as both a preservative and a chelating agent.

The present invention also includes a method of manufacturing a coating system. In one embodiment of the invention, the method includes the steps of providing water and a dispersing agent and then mixing the water with the dispersing agent to form a dispersed solution. Next, the method includes mixing a chitosan based agent in solution form with the dispersed solution under agitation to form a dispersed chitosan based solution. Further, the dispersed chitosan based solution is combined with rheology modifiers and defoamers until the dispersed chitosan based solution is stabilized. Urethane and/or acrylic resins may then be individually combined with the stabilized dispersed chitosan based solution.

In one embodiment of the present invention, such as when a low gloss finish is manufactured, the method of the present invention may further include the step of adding matting agents after the urethane and acrylic resins are combined with the stabilized dispersed chitosan based solution. In a further embodiment of the present invention, the method may further include the step of adding a premix to the stabilized dispersed chitosan based solution. For example, the premix may include one or more of water, solvents, wetting agents, defoamers, and plasticizers.

In an embodiment of the present invention, the dispersing agent may be a wetting agent. Further, in an embodiment of the present invention, the chitosan based solution may be chitosan acetate and salts thereof, chitosan citrate acetate and salts thereof, or combinations thereof. The coating system of the method of the present invention may be a cleaner, a polish, or a finish. When the coating system is a cleaner, the pH of the chitosan based agent may be less than 7. When the coating system is a polish or a finish, the pH of the chitosan based agent may be 6 to 10.

In one embodiment of the method of the present invention, the coating system includes 0.01-5 weight percent chitosan based agent. In another embodiment of the method of the present invention, the coating includes 0.01-1.0 weight percent chitosan based agent. In yet another embodiment of the method of the present invention, the coating system includes 0.01-0.5 weight percent chitosan based agent. In yet even another embodiment of the method of the present invention, the coating system includes 0.01-0.4 weight percent chitosan based agent.

Further features of the present invention will be apparent from the description that follows. After review, such features may in part be obvious from the description or may be learned by practice of the invention. It is to be understood that both the foregoing general description and the following detailed description are exemplary and explanatory only and are not restrictive of the invention, as claimed.

### DETAILED DESCRIPTION OF THE INVENTION

The present invention relates to a coating system and method of making same. The coating system may be in the form of a cleaner, polish, and/or finish that is applied to substrates and surfaces. The coating system of the present invention includes a chitosan based agent such as chitosan acetate, chitosan acetate lactate, chitosan citrate acetate and combinations thereof. The chitosan based agent functions as a preservative to increase both the shelf-life and use-life of the coating system. Particularly, incorporation of the chitosan based agent in the coating system prevents the growth of microbes while not adversely impacting the functional characteristics of the coating system. Moreover, incorporation of the chitosan based agent into the coating system may also function to assist with maintaining cleaner pH levels over time as well as function as a chelating agent to reduce soap scum.

The coating system of the present invention may include a carrier agent, such as a cleaning agent, a polishing agent, and/or a finishing agent, combined with a chitosan based agent preservative, such as chitosan acetate or chitosan citrate acetate. The coating system of the present invention may be combined with further components and/or additives depending on the intended use of the coating system.

Although primarily described herein in terms of its use as a cleaner, polish, and/or finish, it will be clear that the coating system of the present invention may have various other uses. Further, while the chitosan based agent extends the shelf-life and use-life of a coating system, such as a cleaner, polish, and/or finishing agent, it may also exhibit additional beneficial characteristics and properties.

Unless otherwise stated, the following terms used in the specification and claims have the meanings given below.

“Chelating agent” is an agent with molecules that form bonds with metal ions found in water to prevent the metal ions from forming soap scum.

“Chitin” is a fibrous substance commonly derived from the exoskeletons of arthropods and crustaceans. The chitin based components of the present invention are typically derived from shellfish. They have further been discovered in fungus such as mushrooms. While chitin has various known applications, such as preventing growth in systems such as textiles and food, chitin is insoluble in conventional solvents and therefore has not been used in connection with coating systems.

“Chitosan” is a derivative of chitin, which is typically soluble in organic acids but cannot be incorporated into solutions having a pH around 7 without premature precipitation.

“Chitosan based agent” is a derivative of chitosan that can be incorporated into solutions having a pH around 7 without premature precipitation and functions as a preservative when combined with such solutions. Chitosan based agents include at least chitosan acetate, lactate, citrate acetate, and combinations thereof and salts thereof.

“Preservative” is a substance that is added to a composition to control decomposition and/or unwanted microbial growth of such substance.

Reference now will be made in detail to embodiments and examples of the present invention. The particular components and amounts thereof recited in these examples, as well as other conditions and details, should not be construed to unduly limit this invention. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. In the examples and discussion throughout this description, all percentages, proportions and ratios are by weight (mass) unless otherwise indicated.

As stated above, a coating system incorporating a chitosan based preservative agent is disclosed. The coating system includes a carrier agent and a preservative in the form of a chitosan based agent. The chitosan based agent may be a chitosan acetate solution and salts thereof. Further the chitosan based preservative may be a chitosan citrate acetate solution and salts thereof. Further alternatively, the chitosan based agent may be a combination of a chitosan acetate solution and chitosan citrate acetate solution and respective salts thereof. In one embodiment of the present invention, the carrier agent may be a cleaning agent, a polishing agent, and/or a finishing agent.

In an embodiment of the present invention, the coating system may include 0.01-5 weight percent chitosan based agent. In another embodiment of the present invention, the coating system may include 0.01-2.0 weight percent chitosan based agent. In another embodiment of the present invention, the coating system may include 0.01-1.0 weight percent chitosan based agent. In yet another embodiment of the present invention, the coating system may include 0.01-0.80 weight percent chitosan based agent. And in yet another embodiment of the present invention, the coating system may include 0.01-0.1 weight percent chitosan based agent.

In an embodiment of the present invention where the carrier agent is a cleaning agent, the coating system may include 0.01-0.4 weight percent chitosan based agent. Further, when the coating system incorporates a cleaning agent combined with the chitosan based agent, the chitosan based agent preferably has a pH of less than 7 and greater than 2. More preferably, the chitosan based agent has a pH of 3 to 7 for use in connection with a cleaning agent. Alternatively, in an embodiment of the present invention where the carrier agent is a polishing agent or a finishing agent, the coating system may include 0.01-0.5 weight percent chitosan based agent. Further, when the coating system incorporates a polishing or finishing agent combined with the chitosan based agent, the chitosan based agent preferably has a pH of 6 to 10. More preferably, the chitosan based agent has a pH of 6 to 9 for use in connection with polishing and/or finishing agents.

In an embodiment of the present invention, the coating system includes a pH of 3-10. More preferably, the coating system includes a pH of 6-8. Even more preferably, the coating system includes a pH of 6.5-7.5.

The present invention also includes a method of manufacturing a coating system. In one embodiment of the invention, the method includes the steps of providing water and a dispersing agent and then mixing the water with the dispersing agent to form a dispersed solution. Next, the method includes mixing a chitosan based agent in solution form with the dispersed solution under agitation to form a dispersed chitosan based solution. Further, the dispersed chitosan based solution is combined with rheology modifiers and defoamers until the dispersed chitosan based solution is stabilized. When a polish or finish coating system is formed, urethane and/or acrylic and alkyds as resins may then be individually combined with the stabilized dispersed chitosan based solution.

In one embodiment of the present invention, such as when a low gloss finish is manufactured, the method of the present invention may further include the step of adding matting agents after the urethane and acrylic resins are combined with the stabilized dispersed chitosan based solution. In a further embodiment of the present invention, the method may further include the step of adding a premix to the stabilized dispersed chitosan based solution. For example, the premix may include one or more of water, solvents, wetting agents, defoamers, and plasticizers.

In an embodiment of the present invention, the dispersing agent may be a wetting agent. Further, in an embodiment of the present invention the chitosan based agent in solution form may be chitosan acetate and salts thereof, chitosan citrate acetate and salts thereof, and/or combinations thereof. The coating system of the method of the present invention may be a cleaner, a polish, or a finish.

In one embodiment of the method of the present invention, the coating system includes 0.01-5 weight percent chitosan based agent. In another embodiment of the method of the present invention, the coating system includes 0.01-2.0 weight percent chitosan based agent. In another embodiment of the method of the present invention, the coating system includes 0.01-1.0 weight percent chitosan based agent. In yet another embodiment of the method of the present invention, the coating system includes 0.01-0.8 weight percent chitosan based agent. In yet another embodiment of the method of the present invention, the coating system includes 0.01-0.5 weight percent chitosan based agent. In yet even another embodiment of the method of the present invention, the coating system includes 0.01-0.4 weight percent chitosan based agent. Alternatively, in an embodiment of the method of the present invention, the coating system includes 0.01-0.1 weight percent chitosan based agent.

In an embodiment of the method of the present invention where a cleaner is formed, the chitosan based agent preferably has a pH of less than 7 and greater than 2 when mixed with the dispersed solution. More preferably, the chitosan based agent has a pH of 3 to 7. Alternatively, in an embodiment of the method of the present invention where a polish or finish is formed, the chitosan based agent preferably has a pH of 6 to 10 when mixed with the dispersed solution. More preferably, the chitosan based agent has a pH of 6 to 9. Preferably, the dispersed solution has a pH of 6 to 9 when mixed with the chitosan based agent.

Applicant's determined that while the incorporation of chitin and/or chitosan into coating systems such as cleaners, polishes, and finishes creates a negative effect on product efficiency and clarity, the addition of chitosan based agent, such as chitosan acetate and/or chitosan citrate acetate, at certain component ranges as set forth herein, had the opposite effect and was highly beneficial to the coating system.

Namely, the chitosan based coating systems of the present invention prevents microbial attacks of certain cleaners, polishes, and finishes. Additionally, the particle size and pH of such cleaners, polishes, and finishes are maintained, which is important for maintaining clarity on surfaces as well as in a can or bottle. Moreover, the chitosan based agent functioned as a buffering system to maintain pH over an extended period of time and functioned as a chelating agent to reduce soap scum.

Having generally described this instant disclosure, a further understanding can be obtained by reference to certain specific examples illustrated below which are provided for purposes of illustration only and are not intended to be all inclusive or limiting unless otherwise specified.

### Examples & Testing

The preparation, identification, and testing of example compositions of this disclosure are further described below. The particular materials and amounts thereof recited in these examples, as well as other conditions and details, should not be construed to unduly limit this invention.

The chitosan based coating system of the present invention was tested against microbes such as Staphylococcus aureus, Aspergillus brasiliensis, Pseudomonas aeruginosa, Candida albicans, and Escherichia coli. The coating system was prepared using the following steps: (1) add water to a vessel; (2) slowly add and gently mix in any wetting or dispersing agents; (3) under agitation slowly add solution of chitosan based agent such as chitosan citrate acetate and gently mix for 3-5 minutes; (4) add any rheology modifiers and/or process defoamers. For cleaners, the chitosan based agent had a pH of less than 7 when mixed with the solution. For polishes and finishes, the following step may be incorporated: (5) once rheology modifiers and defoamers are stabilized, add urethane and acrylic resins slowly one at a time. Additionally, for polishes and finishes, the chitosan based agent may have a pH of 6 to 9 when mixed with the solution. For low gloss finishes, matting agents may be added to the system after the addition of the urethane and/or acrylic resins. Finally, premixes that may contain water, solvents, wetting agents, defoamers, and plasticizers may be incorporated at the end of the process.

In coating systems with cleaning agents, growth of microbes were prevented at levels of at least from 0.01-0.4 weight percent of chitosan citrate acetate in the formulation.

The chitosan based agent was incorporated with a polyurethane-acrylic polish. Similar steps to the above were used to make the polish coating system. The system was tested against microbes such as Staphylococcus aureus, Aspergillus brasiliensis, Pseudomonas aeruginosa, Candida albicans, and Escherichia coli. In the polish coating system, growth of microbes were prevented at levels of at least from 0.01-0.5 weight percent chitosan based agent such as chitosan citrate acetate in the formulation.

The chitosan based agent was incorporated with a water-based polyurethane finish. Similar steps to the above were used to make the finish coating system. The system was tested against microbes such as Staphylococcus aureus, Aspergillus brasiliensis, Pseudomonas aeruginosa, Candida albicans, and Escherichia coli. In the finish coating system, growth of microbes were prevented at levels of at least from 0.01-0.5 weight percent chitosan based agent such as chitosan citrate acetate in the formulation.

In all of the coating systems tested, the chitosan based agent created a buffer capacity to the polishes and finishes. Additionally, the chitosan based agent assisted in defoaming the products when they were applied to flooring in a vigorous manner. The coating systems tested did not result in loss of gloss or flocculation, viscosity change, pH drift, or color change. None of these issues were noted with the testing on a shelf in an oven at 50° C. Additionally, the chitosan based agent functioned as a chelating agent in all of the coating systems tested.

While various embodiments and examples of this invention have been described above, these descriptions are given for purposes of illustration and explanation, and not limitation. Variations, changes, modifications, and departures from the systems and methods disclosed above may be adopted without departure from the spirit and scope of this invention. In fact, after reading the above description, it will be apparent to one skilled in the relevant art(s) how to implement the invention in alternative embodiments. Thus, the present invention should not be limited by any of the above described exemplary embodiments.

Further, the purpose of the Abstract is to enable the various patent offices and the public generally, and especially the scientists, engineers, and practitioners in the art who are not familiar with patent or legal terms or phraseology, to determine quickly from a cursory inspection the nature and essence of the technical disclosure of the application. The Abstract is not intended to be limiting as to the scope of the invention in any way.

1. A coating system comprising:
a carrier agent, wherein the carrier agent is a cleaning agent; and
a preservative comprising a chitosan based agent, wherein the chitosan based agent is chitosan acetate solution and salts thereof, chitosan citrate acetate solution and salts thereof, or combinations thereof.

2. The coating system of claim 1, wherein the chitosan based agent is chitosan acetate solution and salts thereof.

3. The coating system of claim 1, wherein the chitosan based agent is chitosan citrate acetate solution and salts thereof.

4. The coating system of claim 1, wherein the coating system comprises 0.01-5 weight percent chitosan based agent.

5. The coating system of claim 1, wherein the coating system comprises 0.01-1.0 weight percent chitosan based agent.

6. The coating system of claim 5, wherein the chitosan based agent is chitosan acetate and salts thereof.

7. The coating system of claim 5, wherein the chitosan based agent is chitosan citrate acetate solution and salts thereof.

8. (canceled)

9. The coating system of claim 1, wherein the coating system comprises 0.01-0.4 weight percent chitosan based agent.

10. The coating system of claim 1, wherein the chitosan based agent has a pH less than 7.

11. A coating system comprising:
a carrier agent, wherein the carrier agent is a polishing agent; and
a preservative comprising a chitosan based agent, wherein the chitosan based agent is chitosan acetate solution and salts thereof, chitosan citrate acetate solution and salts thereof, or combinations thereof.

12. The coating system of claim 11, wherein the coating system comprises 0.01-0.8 weight percent chitosan based agent.

13. The coating system of claim 11, wherein the coating system comprises 0.01-0.5 weight percent chitosan based agent.

14. The coating system of claim 11, wherein the chitosan based agent has a pH of 6 to 9.

15. A coating system comprising:
a carrier agent, wherein the carrier agent is a finishing agent; and
a preservative comprising a chitosan based agent, wherein the chitosan based agent is chitosan acetate solution and salts thereof, chitosan citrate acetate solution and salts thereof, or combinations thereof.

16. The coating system of claim 15, wherein the coating system comprises 0.01-0.8 weight percent chitosan based agent.

17. The coating system of claim 15, wherein the coating system comprises 0.01-0.5 weight percent chitosan based agent.

18. The coating system of claim 15, wherein the chitosan based agent has a pH of 6 to 9.

19. The coating system of claim 1, wherein the chitosan based agent also functions as a chelating agent.

20. A method of making a cleaning, polishing, and finishing coating system comprising the steps of:
providing water and a dispersing agent;
mixing water with the dispersing agent to form a dispersed solution;
mixing a chitosan based agent in solution form with the dispersed solution under agitation to form a dispersed chitosan based solution, wherein the chitosan based agent is chitosan acetate and salts thereof, chitosan lactate and salts thereof, chitosan citrate acetate and salts thereof, or a combination thereof; and
combining the dispersed chitosan based solution with rheology modifiers and defoamers until the dispersed chitosan based solution is stabilized.

21. The method of claim 20 further comprising the steps of combining urethane with the stabilized dispersed chitosan based solution and combining acrylic resins with the stabilized dispersed chitosan based solution.

22. The method of claim 20 further comprising the step of adding matting agents after the urethane and acrylic resins are combined with the stabilized dispersed chitosan based solution.

23. The method of claim 22, wherein the coating system is a low gloss finish.

24. The method of claim 20, wherein the dispersing agent is a wetting agent.

25. The method of claim 20 further comprising the step of adding a premix to the stabilized dispersed chitosan based solution, wherein the premix includes one or more of water, solvents, wetting agents, defoamers, and plasticizers.

26. The method of claim 20, wherein the chitosan based agent is chitosan acetate and salts thereof.

27. The method of claim 20, wherein the chitosan based agent is chitosan citrate acetate and salts thereof.

28. The method of claim 20, wherein the coating system is a cleaner and the chitosan based agent has a pH of less than 7.

29. The method of claim 20, wherein the coating system is a polish or a finish and the chitosan based agent has a pH of 3 to 9.

30. The method of claim 20, wherein the coating system comprises 0.01-5 weight percent chitosan based agent.

31. The method of claim 20, wherein the coating system comprises 0.01-1.0 weight percent chitosan based agent.

32. The method of claim 20, wherein the coating system comprises 0.01-0.5 weight percent chitosan based agent.

33. The method of claim 20, wherein the coating system comprises 0.01-0.4 weight percent chitosan based agent.
